(19) United States
(12) Patent Application Publication
(10) Pub. No.: US 2014/0068120 A1
(43) Pub. Date: Mar. 6, 2014

(54) HOST SYSTEM, STORAGE DEVICE AND COMMUNICATION METHOD

(71) Applicant: KABUSHIKI KAISHA TOSHIBA, Tokyo (JP)

(72) Inventor: Hiroaki TANAKA, Kanagawa (JP)

(73) Assignee: KABUSHIKI KAISHA TOSHIBA, Tokyo (JP)

(21) Appl. No.: 13/786,422

(22) Filed: Mar. 5, 2013

(30) Foreign Application Priority Data
Aug. 30, 2012 (JP) 2012-190192

(51) Int. Cl. G06F 13/10

(52) U.S. Cl. CPC G06F 13/10
USPC 710/74

(57) ABSTRACT

A host system which maybe connected to a storage device has an application module and a communication interface section. The application module issues commands for the operation of the storage device. The communication interface transmits the commands issued by the application module. The commands are placed in a frame unit which can include multiple commands stored in a command packet. A storage device that may be connected to the host system receives the frame unit, then retrieves the commands from the command packet and executes the commands. By communicating in frame units containing multiple commands, the communication efficiency between host system and storage device can be improved.

### CROSS-REFERENCE TO RELATED APPLICATION

This application is based upon and claims the benefit of priority from Japanese Patent Application No. 2012-190192, filed Aug. 30, 2012; the entire contents of which are incorporated herein by reference.

### FIELD

Embodiments described herein relate to a host system, a storage device and a communication method.

### BACKGROUND

In the recent years, the transmission speed of the communication lines connecting computers and other host systems and hard disk drives (HDD), solid state drives (SSD), and other storage devices has been rapidly increasing. For example, according to the second-generation SATA (Serial Advanced Technology Attachment), the communication speed is defined up to 3.0 Gbps (300 MB/s). In the future, even higher communication speeds will be required; therefore it is desirable to improve communication efficiency.

### DESCRIPTION OF THE DRAWINGS

FIG. 1 is a schematic diagram illustrating the communication procedure based on the SATA standard between the host device and the storage device.

FIG. 2 is a diagram illustrating the frame structure of a frame information structure (FIS).

FIG. 3 is a diagram illustrating in detail the procedure for transmission of a frame information structure (FIS).

FIG. 4 is a schematic diagram illustrating the operation of a host device.

FIG. 5 is a schematic diagram illustrating the operation of the storage device.

FIG. 6 is a diagram illustrating a frame according to an embodiment.

FIG. 7 is a diagram illustrating a host system and a storage device according to an embodiment.

FIG. 8 is a diagram illustrating the data structure of a packet.

FIG. 9 is a flow chart illustrating the operation of a communication control section equipped in a storage device.

FIG. 10 is a flow chart illustrating the operation of a controller module.

### DETAILED DESCRIPTION

The present disclosure describes a host system, a storage device, and a communication method having improved communication efficiency. In general, according to one embodiment, the host system, the storage device, and the communication method will be explained with reference to the figures.

According to an embodiment a host system comprises an application module which can issue commands (e.g., read/write data) to a storage device, and a communication interface which can transmit the commands to the storage device in a frame unit including a command packet. A plurality of commands from the application module is stored in the command packet.

According to another embodiment a storage device includes at least one memory unit, a communication control module configured to receive a frame unit from a host system, and a controller module. The frame unit can contain a plurality of commands from the host system. The controller module can retrieve the commands from the command packet then execute the commands as required.

According to another embodiment of the present disclosure, the host system connected to the storage device via a communication line has an application module and a communication interface. The application module issues the commands for the storage device. The communication interface executes the transmission of the issued command from the host system to the storage device. The transmission processing generally includes adding header information, error correction information, and other information to the issued command before sending the command to the storage device. For example, the command (and additional information) may be included in a frame unit as prescribed by the communication protocol to be used. A frame unit may include additional information such as command identification information, error correction information, and header information. The communication interface executes the transmission processing for each command issued by the application section and transmits each command along with additional information (such as, file header information and identification information) to the storage device. The communication interface in an embodiment of the present disclosure is also configured to include multiple commands within a single command packet when the application section issues multiple commands. The communication interface forms a packet that accommodates the multiple commands, and then transmits the packet to the storage device by the same transmission processing used for a single command. That is, the packet of multiple commands issued by the application section is included in a single frame unit including additional information (such as command identification information, error correction information, and header information) according to the requirements of the communication protocol.

### Example Embodiment

First of all, a brief account will be given on an example of the communication between the host system and the storage device carried out according to the SATA standard with reference to FIG. 1 to FIG. 3. FIG. 1 is a schematic diagram illustrating the communication procedure on the transport layer level executed on the basis of the SATA standard between the host system (host) and the storage device (storage). The arrows indicate one FIS (Frame Information Structure). Here, an example of a write of the user data by the host to the storage device will be presented.

As shown in FIG. 1, the host has sent a particular FIS known as “Register Host to Device” (Reg HD) the storage device. This Reg HD FIS contains a write command. According to the SATA standard, communication is carried out between the host and the storage using the data structure known as FIS (Frame Information Structure). According to the SATA standard, 8 types of FIS are defined. The Reg HD signal is one of the various types of FIS. The Reg HD FIS is adopted when a command is issued by the host to the storage. In the following, among the Reg HD FIS, the Reg HD FIS may have either a read or write command stored.

For the storage, when the write command is received in the Reg HD FIS, a FIS known as the “Register Device to Host” (Reg DH) containing the status information known as “Clear Interface Busy” is transmitted to the host, and the communication line between the storage and the host is opened. Then, the storage device makes preparation for executing the write command. As a result, a FIS known as “DMA Setup FIS” is sent to notify the host to begin data transmission instructions for the write command. Also, according to the SATA standard, the storage device has a read/write command queue, and it is possible to execute the read/write commands stored in the queue in a sequence arranged to improve device efficiency (out of order execution), and the NCQ (Native Command Queuing) function is thus defined. According to the NCQ function, the storage device can store up to 32 read/write commands received from the host in queue. By storing the information that makes preparation for execution of the read/write commands stored in queue (command identification information, to be referred to as tag information below) in the DMA Setup FIS and transmitting the information, the storage device can assign the command as the execution start object (that is, select a command from the queue for execution).

Upon receiving of the DMA Setup FIS, the write data related to the write command (or, more accurately, the write command assigned by the DMA Setup FIS) are transmitted using the FIS known as the “Data FIS.” The Data FIS is a FIS that can store up to 2048 Dword (=8192 bytes). Although not shown in FIG. 1, when the size of the write data is over 2048 Dword, another FIS known as “DMA Activate FIS” is transmitted from the device to the host, so that the host can transmit a later Data FIS to accommodate the data over the 2048 Dword.

Upon end of reception of the write data, the storage includes status information (status) in the FIS known as the “Set Device Bits” and transmits this FIS to the host.

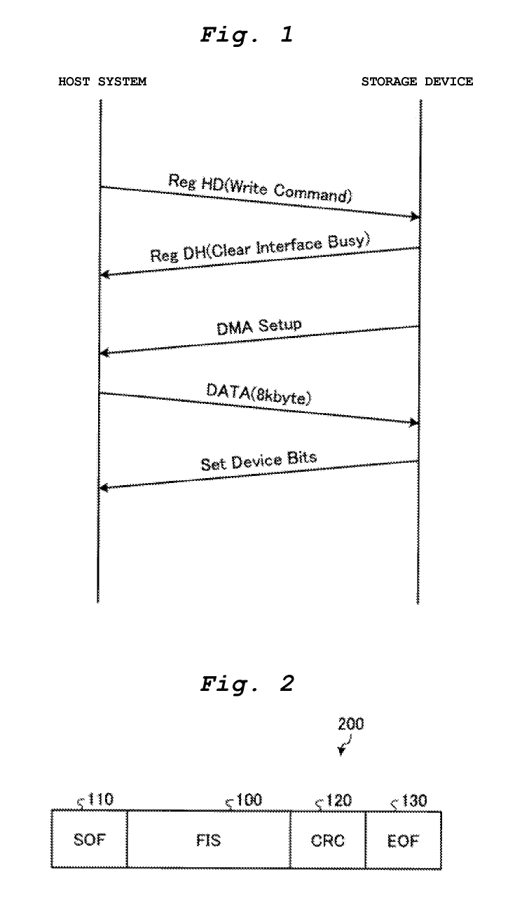

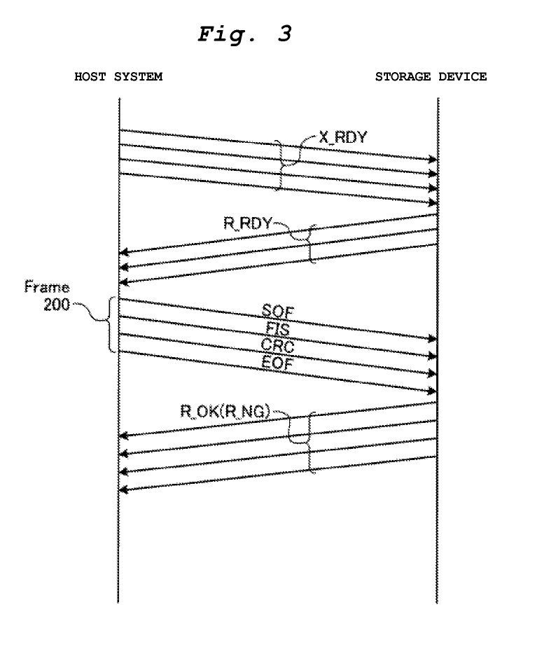

FIG. 2 is a diagram illustrating the structure where the frame having the FIS as the data of the transport layer in the data link layer carried. FIG. 3 is a diagram illustrating transmission procedure of a FIS from the host system to the storage device from the viewpoint of the data link layer. As shown in FIG. 2, a FIS 100 forms a frame 200 together with a SOF (start of frame) 110 that incorporates a primitive command/instruction indicating a start of transmission for the FIS 100, a CRC (cyclic redundancy check) 120 adopted for detecting errors in the transmission/reception of FIS 100, and an EOF (end of frame) 130 incorporating a primitive command/instruction that indicates the end of transmission of the FIS 100. Before the frame 200 is transmitted, as shown in FIG. 3, a handshake is carried out between the host and the storage by transmitting the primitive “X_RDY” and the primitive “R_RDY”. In addition, as shown schematically in FIG. 3, X_RDY and R_RDY are sent repeatedly in multiple rounds until the counterpart makes a reply. Upon end of handshake, the frame 200 is transmitted. Then, after the storage device receives the frame 200, the primitive “R_OK” or “R_NG” is transmitted to indicate whether the transmission process was successful or not.

According to the SATA standard, a 3-layer conceptual structure including a physical layer, a link layer, and a transport layer counted from the bottom side is defined. On the basis of the request from a high-order layer (such as operating system OS), the transport layer generates the FIS 100, and sends the generated FIS 100 to the link layer. Also, the layer that carries out the request for the transport layer is known as the application layer. For example, when the application layer generates the read/write command, the transport layer generates the Reg HD (that is, the command FIS) that stores the generated read/write command. The link layer generates the CRC 120 for the FIS 100 sent from the transport layer. It attaches the SOF 110, the generated CRC 120 and the EOF 130 to the command FIS 100, to generate the frame 200. The physical layer transmits the frame 200 generated in the link layer as a differential signal. In addition, the primitives such as X_RDY, R_RDY, in addition to the SOF 110, and the EOF 130 are also transmitted/received by the physical layer under control of the link layer. The following, explanation will be made on the command FIS as FIS 100, so that the command FIS will be denoted by attaching key 100 on it.

The command FIS 100 has the data structure with a size of 5 DWORD. According to the second-generation SATA standard, transmission of the command FIS 100 itself ends in about 66 ns. However, as explained above, the transmission treatment (processing) for one transmission unit including the command FIS 100 also includes a series of prescribed additional steps, such as transmission/reception of the X_RDY, R_RDY, the inclusion and transmission of SOF 110, the CRC 120, and the EOF 130 in addition to the transmission of the command FIS 100 itself. As these series of additional treatments are required, according to the communication protocol, for each transmission unit, the transmission treatment of a single command FIS 100 takes a longer than 66 ns since the communication protocol overhead (handshake, error correction, frame information inclusion, etc.) must also be accounted for in the overall transmission processing time. Thus, the transmission treatment related to the transmission of a single command FIS 100 typically requires a time of about 1.1 μs. As the communication line is kept in the active line state over the entire period for this transmission processing, there is a lot of waste with both respect to time and power consumption. That is, the communication efficiency is poor.

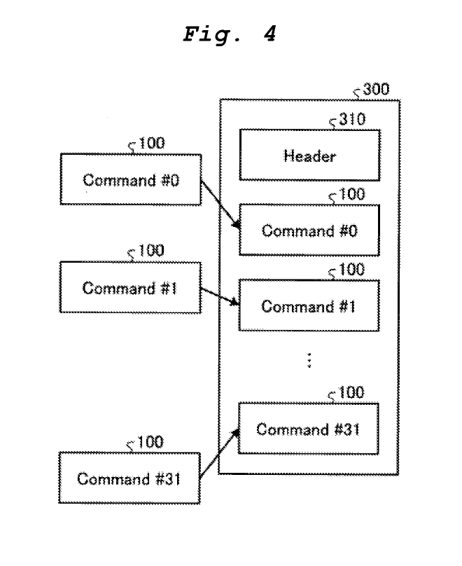

According to an embodiment of the present disclosure, plural commands FIS 100 are packed into a single packet, and then the transmission/reception processing are carried out for one packet as the transmission unit. In the following, a first embodiment will be explained schematically with reference to FIG. 4 to FIG. 6.

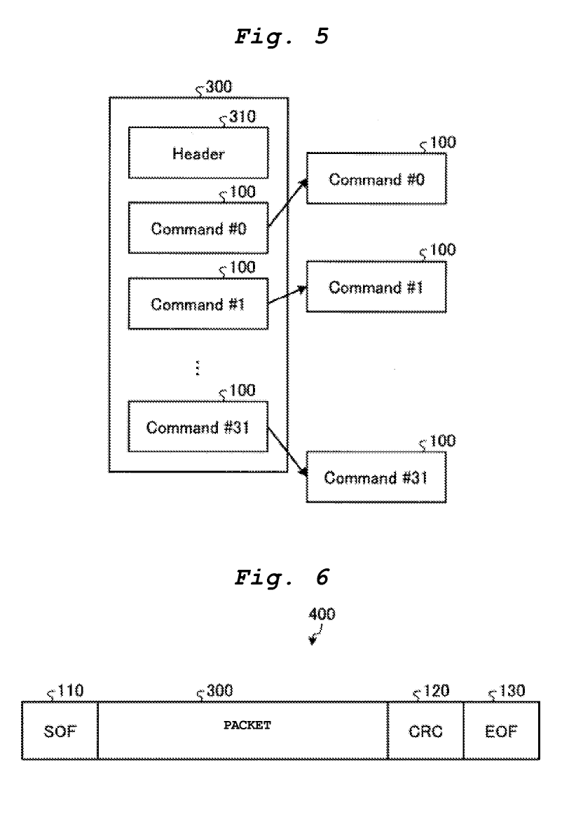

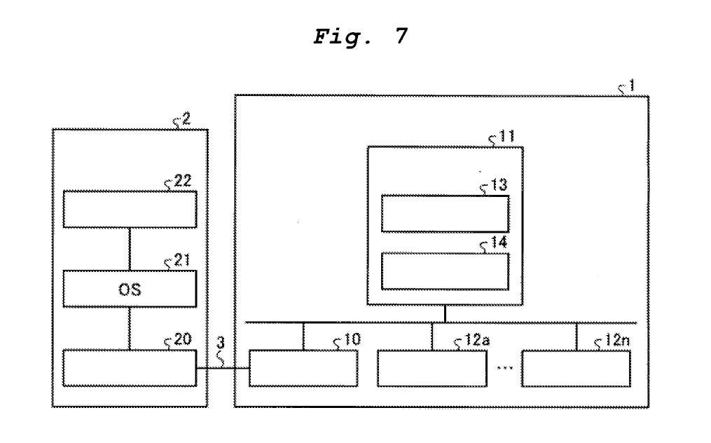

FIG. 4 is a diagram illustrating schematically the operation of the host. When 32 commands (read/write commands) are issued by the application layer, the host generates, in the transport layer, command FIS 100 for each command, and these commands FIS 100 are stored together with a header 310 in a single data structure. The data structure with multiple commands FIS 100 stored in it is called a packet (packet 300) in this invention. In the link layer, the host has a SOF 110, a CRC 120 and a EOF 130 attached to or included with the packet 300, and a frame 400, shown in FIG. 6, is generated. After the transmission/reception of the various primitives is carried out, and handshake is executed, the link layer sends the frame 400 via a physical layer to the storage device.

FIG. 5 is a schematic diagram illustrating the operation of the storage device. As the frame 400 in the physical layer is received, the packet 300 is fetched from the link layer. Then, in the transport layer, the storage fetches the 32 commands FIS 100 contained in the packet 300. The 32 commands FIS 100 that have been fetched are stored in the queue, and the out of order execution can be carried out.

FIG. 7 is a diagram illustrating the construction of the host system and the storage device adopted in an embodiment of the present disclosure. As shown in the figure, the storage device (storage) 1 is connected to the host system (host) 2 by a communication line 3 of the SATA standard, and the storage device 1 functions as an external memory device of the host 2. Here, the host 2 maybe a cell phone or a personal computer, for example. Also, a storage device 1 may be a HDD (Hard Disk Drive) or SSD (Solid State Drive), for example.

The host 2 has a communication control section 20, an application 22, and an operation system (OS) 21 that provides an environment for executing software on the hardware resources of the host 2.

The functions of the OS 21 and the application 22 are realized by a computer equipped in the computing device and the memory device, which may store instructions or data as required by the OS 21 and the application 22. More specifically, the functions of the OS 21 and the application 22 may be realized as a corresponding program stored in the memory device which is then read from the computing device and executed.

The application 22 assigns file names and carries out the read/write request in conjunction with OS 21.

The OS 21 has the function of an application layer (application section). For example, the OS 21 determines the head address and the size of the file of the region of the storage destination of the file of the read/write request issued by the application 22, and it generates the read/write command containing the determined head address and the file size.

The communication control section 20 is the connection interface of the communication line 3. Here, as an example, it has the function in controlling the transport layer and the layers thereafter, that is, the function of the communication interface of the host 2. More specifically, when multiple commands are generated from the OS 21, the communication control section 20 generates the commands FIS 100 from the issued commands, and packs the generated commands FIS 100 to generate the packet 300. Then, the frame 400 is generated from the packet 300, and the generated frame 400 is sent to the communication line 3 by the transmission treatment for one transmission unit (which is a frame unit in this instance).

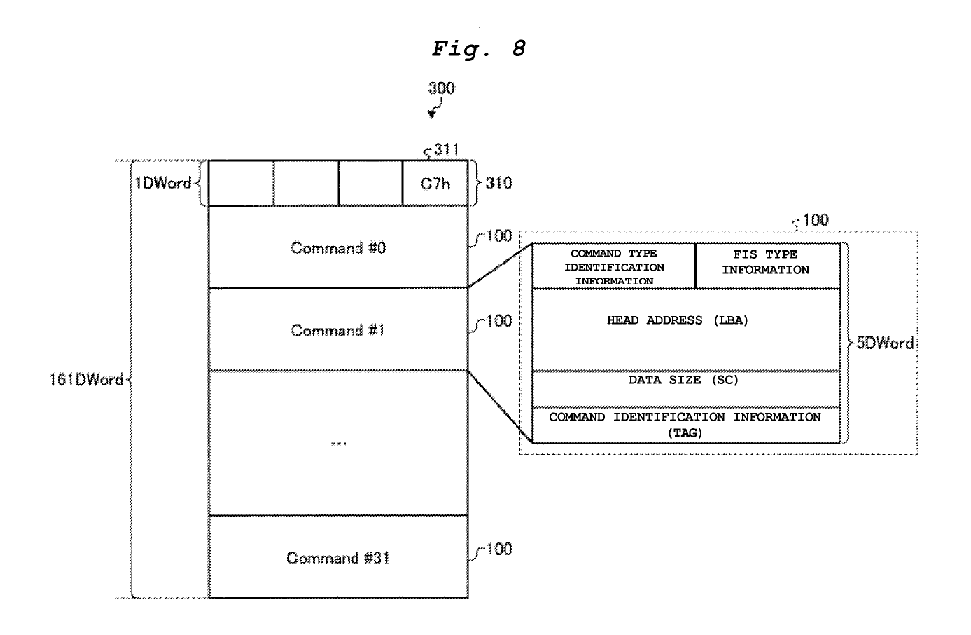

FIG. 8 is a diagram illustrating the data structure of the packet 300 in detail. As shown in the figure, the packet 300 has 32 commands FIS 100 and the header 310.

The header 310 has a size of 1 DWORD (=4 bytes), and the 32 commands FIS 100 each have a size of 5 DWORD, so that the overall size of the packet 300 is 161 DWORD. The header 310 contains a packet identification information 311 1 byte in size. The packet identification information 311 is the information indicating the fact that the header 310 and the contents after the header 310 form the data structure of the packet 300 having a size of 161 DWORD. In FIG. 8, as an example, the function has the value of “C7h” taken as the packet identification information 311.

Each command FIS 100 contains a command type identification information, a FIS type information, a head address, a data size, and command identification information (tag). The command type identification information is the information indicating the type of the command (whether it is a read command or a write command, etc.). The FIS type information is the information indicating what type of FIS among the 8 types of FIS the command FIS 100 is. The head address indicates the address of the head of the region of the access destination, and it is described in the form of the LBA (Logical Block Addressing). The data size shows the size of the data as the access object, and it is represented by the sector counts (SC). The tag information identifies the 32 commands stored in the queue, respectively. That is, each of the 32 commands in the packet is associated with a distinct tag, and thus may be identified by reference to the tag information.

Now, return to FIG. 7. Here, the storage device 1 has a communication control section 10, a controller (controller module) 11, and one or more memory sections (here, memory sections 12a to 12n). The communication control section 10, the controller 11 and the memory sections 12a to 12n are connected with each other by a bus.

The memory sections 12a to 12n are nonvolatile memory devices that store the write data from the host 2. For example, when the storage 1 is an SSD, the memory sections 12a to 12n each correspond to the memory chips that carry a memory cell array.

The communication control section 10 is a connection interface of the communication line 3. Here, as an example, it has the conceptual function of controlling the link layer and the physical layer. The communication control section 10 fetches the packet 300 from the frame 400 received via the communication line 3 in the transmission treatment of one unit, and it then sends the fetched packet 300 to the controller 11.

The controller 11 carries out the overall control of the storage device 1. In addition, the controller 11 has the function of controlling the transport layer of the communication line 3 and the function of the application layer. Here, the communication control section 10 and the control function of the transport layer of the controller 11 work together to form the communication interface section (communication control module) of the storage device 1.

The controller 11 has the function of controlling the transport layer. Controller 11 has a packet decomposing section 13, which fetches the multiple commands FIS 100 from the packet 300 and stores the commands stored in the fetched commands FIS 100 in the queue (not shown), and an analysis/execution section 14 that makes analysis/execution of the commands FIS 100 stored in the queue.

In addition, the function of the controller module 11 maybe realized by the same hardware constitution as a computer equipped with a typical computing device and a memory device. More specifically, the controller 11 may, for example, realize its functions by executing the operation by the computing device with the firmware pre-stored in the memory device of itself or the memory sections 12a to 12n.

In the following, the operation of the host 2 and the storage device 1 will be explained.

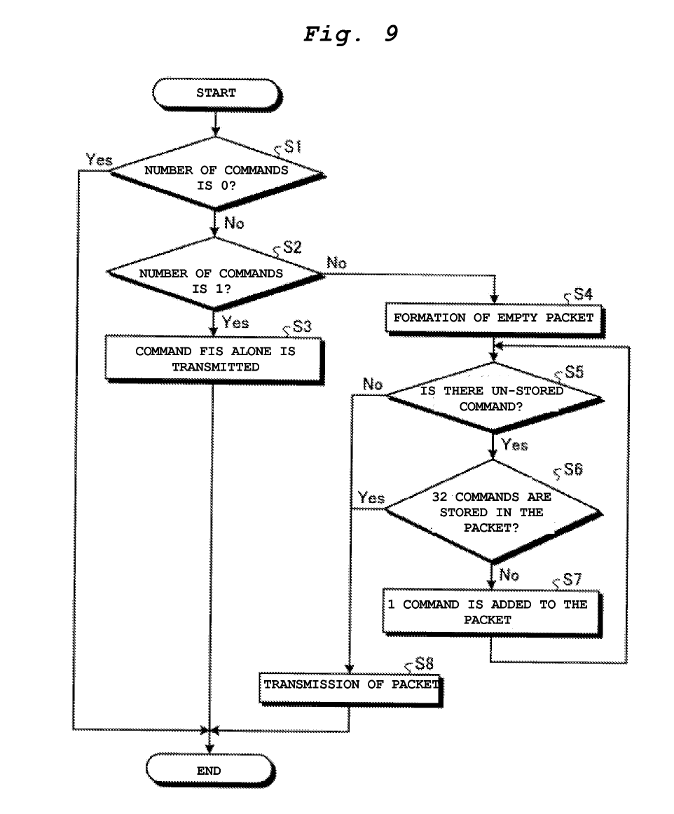

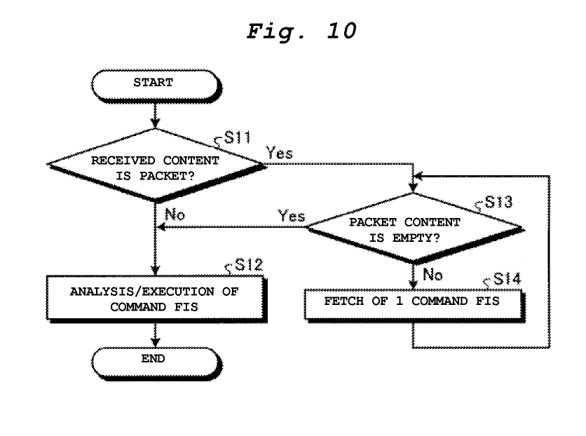

As explained above, when the OS 21 issues multiple commands, the communication control section 20 can generate a packet 300 from the issued commands. FIG. 9 is a flow chart illustrating the operation of the communication control section 20 equipped in the host 2.

First of all, the communication control section 20 determines whether the number of issued commands is “0” (step S1), and whether the number of the issued commands is “1” (step 2). When the number of issued commands is “0” (YES in step S1), the communication control section 20 terminates the operation. When the number of issued commands is “1” (NO in step S1, YES in step S2), the communication control section 20 generates the command FIS 100 from the issued single command, and it then transmits the generated command FIS 100 alone (step S3). That is, the communication control section 20 generates the frame 200 shown in FIG. 2 from the command FIS 100, and transmits the generated frame 200 to the storage device 1. After the treatment in step S3, the communication control section 20 terminates the operation.

When the number of issued commands is two or more (NO in step S1 and NO in step S2), the communication control section 20 generates an empty packet 300 (step S4). Here, the empty packet 300 refers to a packet 300 that has only the header 310 but has no FIS 100 stored in it.

Then, the communication control section 20 executes the loop treatment of steps of operation S5 to S7 and has the issued commands stored in the packet 300 previously prepared in step S4. More specifically, the communication control section 20 determines whether there is a command not stored in the packet 300 (step S5). When there is a command not stored (YES in step S5), the communication control section 20 determines whether the packet 300 stores 32 commands (step S6). If the packet 300 does not store 32 commands (NO in step S6), the communication control section 20 adds another command to the packet 300 (step S7). That is, the communication control section 20 selects one un-stored command, generates the command FIS 100 from the selected command, and stores the generated command FIS 100 in the packet 300. The communication control section 20 executes the determination treatment of step S5 after the treatment of step S7.

When there is no un-stored command (NO in step S5), or when 32 commands are already stored in the packet 300 (YES in step S6), the communication control section 20 transmits the packet 300 to the storage device 1 (step S8). That is, the communication control section 20 generates the frame 400 shown in FIG. 6 from the packet 300, and transmits the generated frame 400 to the storage device 1. After the treatment of step S8, the communication control section 20 terminates the operation.

In the storage device 1, when the frame 200 having a single command FIS 100 stored in it is received via the communication line 3, the communication control section 10 fetches the command FIS 100 from the received frame 200, and sends it to the packet decomposing section 13. Also, when the frame 400 having the packet 300 stored in it is received via the communication line 3, the communication control section 10 fetches the packet 300 from the frame 400, and sends it to the packet decomposing section 13.

FIG. 10 is a flow chart illustrating the operation of the controller 11. In the controller 11, the packet decomposing section 13 determines whether the content sent from the communication control section 10 is the packet 300 (step S11). When the content received from the communication control section 10 is the single command FIS 100 instead of the packet 300 (NO in step S11), the packet decomposing section sends the command FIS 100 via the queue to the analysis/execution section 14, and the analysis/execution section 14 carries out analysis/execution for the command FIS 100 sent to it (step S12).

When the content sent from the communication control section 10 is the packet 300 (YES in step S11), the packet decomposing section 13 executes the loop treatment of the steps S13 and S14, and decomposes the packet 300 sent to it. That is, in step S13, the packet decomposing section 13 determines whether the packet 300 is empty (step S13). If the packet 300 is not empty (NO in step S13), the packet decomposing section 13 fetches one command FIS 100 from the packet 300 (step S14), and it executes the determination treatment of step S13 again. In the treatment in step S14, the packet decomposing section 13 has the fetched command FIS 100 stored in the queue. When the packet 300 is empty (YES in step S13), in the treatment of step S12, the analysis/execution section 14 carries out analysis/execution for the plural commands FIS 100 stored in the queue. In addition, as the analysis/execution section 14 carries out analysis/execution for the command FIS 100, and, when plural commands FIS 100 are stored in the queue, the operation can include the out of order execution of the commands FIS 100. After the treatment of step S12, the controller 11 terminates the treatment related to the communication.

In the above explanation, the embodiment of the present disclosure is assumed to be of the case when generation of the packet 300 and the decomposition of the packet 300 are executed on the transport layer. However, both or one of them may not be executed on the transport layer. For example, generation of the packet 300 or decomposition of the packet 300 may also be carried out on the link layer.

In the above, the function of the storage device 1 as a communication interface (communication control module) has been explained above for an implementation involving a combination of the hardware (communication control section 10) and the software (controller 11). However, it may also be realized by the hardware alone, or by the software alone.

Similarly, in the above, the function of the communication interface of the host 2 has been explained in the case when it is realized by hardware (communication control section 20). However, the function of the communication interface of the host 2 may also be realized partially or entirely by the software.

In the above, explanation has been made on the case when up to 32 commands FIS 100 can be stored in the packet 300. However, the maximum number of the commands FIS 100 that can be stored in the packet 300 is not limited to 32. As a matter of fact, the maximum number of the commands FIS 100 that can be stored in the packet 300 should be the same value as the maximum number that can be stored in the queue on the side of the storage device 1, so that the NCQ function can be efficiently performed.

In addition, in the above, explanation has been made on the case when the communication line 3 is according to the SATA standard. However, the embodiment of the present disclosure may also be adopted in any case when the communication standard (protocol) requires the inclusion/addition of overhead processes or additional data to the transmission data unit for communication between two devices. For example, the communication line 3 may also be based on the SAS standard. When the communication line 3 adopts the SATA standard, it is also possible to adapt the previously described embodiments by change the design of the link layer and higher layers, instead of changing the physical layer.

As explained above, according to an embodiment of the present disclosure, the host 2 has the OS 21 that issues command to the storage device 1 and the communication control section 20 that executes the transmission processing on a transmission unit containing multiple commands (a packet of commands) between it and the storage device 1, and also executes the transmission processing on single commands issued by the OS 21 as the transmission unit (e.g., frame 200). Here, when the OS 21 issues multiple commands, the communication control section 20 also stores the commands in one packet 300, and sends the packet 300 to the storage 1 by a single transmission processing (e.g., sending frame 400). The host 2 can carry out the transmission processing on a single packet 300 that stores multiple commands in it, so that it is possible to have a smaller proportion of time taken up with the transmission processing overhead steps (e.g., handshake process, inclusion/transmission of header information, and error correction processing) since such steps are not required to be repeated for each and every individual command that is transmitted because multiple commands are packaged (i.e., placed in a packet), then processed and transmitted as a single unit. Thusly, it is possible to improve communication efficiency.

Also, the storage device 1 has the communication control section 10 and the packet decomposing section 13, which execute the transmission treatment containing the prescribed annexed treatment of one unit in each unit between it and the host 2, and which execute the transmission treatment of one unit for each of the commands sent from the host 2 to the self storage 1, and the analysis/execution section 14 that carries out analysis/execution for the commands received by the communication interface section. Then, the communication control section 10 receives the packet 300 containing multiple commands by the transmission treatment of one unit for each packet 300. The packet decomposing section 13 fetches the commands contained in the received packet 300, and transfers the fetched plural commands to the analysis/execution section 14. As a result, a storage 2 can receive the packet 300 containing multiple commands by the transmission treatment of one unit, so that it is possible to have a smaller time proportion taking by the annexed treatment among the transmission treatment of one unit than that in the case of execution of the transmission treatment of one unit for each command. Namely, it is possible to obtain the storage 1 of which communication efficiency is practicably high.

Also, for the storage 1, the packet decomposing section 13 can store the commands fetched from the packet 300 in the queue, and the analysis/execution section 14 can carry out the out of order execution of the commands stored in the queue. Consequently, it is possible to carry out the high efficiency communication using the NCQ function with the host 2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A host system, comprising:
an application module configured to issue commands to a storage device; and
a communication interface configured to transmit the commands in a frame unit to the storage device, the frame unit including a command packet in which a plurality of commands from the application module is stored.

2. The host system of claim 1, wherein the communication interface generates the frame unit.

3. The host system of claim 1, wherein the frame unit additionally includes:
a primitive command indicating the start of the frame unit;
a primitive command indicating the end of the frame unit; and
error correction information.

4. The host system of claim 3, wherein the error correction information includes a cyclic redundancy check.

5. The host system of claim 1, wherein the communication interface is configured to perform a handshake operation prior to transmitting the frame unit.

6. The host system of claim 1, wherein each command is placed in a frame information structure.

7. The host system of claim 6, wherein the frame information structure includes command identification information, address information, data size information, and tag information.

8. A storage device connected to a host system, the storage device comprising:
at least one memory unit;
a communication control module configured to receive a frame unit from a host system, the frame unit including a command packet in which a plurality of commands from the host system are stored; and
a controller module configured to receive the plurality of commands from the communication control module and to control the at least one memory unit according to the plurality of commands.

9. The storage device of claim 8, wherein the controller module receives the plurality of commands from the communication control module as a packet, and the controller module further comprises:
a packet decomposition module configured to retrieve each command from the packet; and
an analysis/execution module configured to execute each command retrieved from the packet.

10. The storage device of claim 8, wherein the frame unit received from the host additionally includes:
a primitive command indicating the start of the frame unit;
a primitive command indicating the end of the frame unit; and
error correction information.

11. The storage device of claim 10, wherein the error correction information includes a cyclic redundancy check.

12. The storage device of claim 8, wherein the command packet further includes a command header providing packet identification information.

13. The storage device of claim 8, further comprising a command queue wherein the plurality of commands from the host is stored.

14. The storage device of claim 13, wherein the controller module is configured to execute a command from the plurality of commands stored in the command queue based on execution efficiency rather a storage sequence of the plurality of commands.

15. The storage device of claim 8, wherein communication control module is configured to use a Serial Advanced Technology Attachment (SATA) protocol.

16. The storage device of claim 8, wherein the communication control module is configured to be connected to a communication line including at least one wire.

17. The storage device of claim 8, wherein the at least one memory unit is a nonvolatile semiconductor memory device.

18. A method for controlling a storage device, the method comprising:
receiving a frame unit from a host system;
determining whether the frame unit includes a command packet in which a plurality of commands from the host system is stored; and
if the frame unit includes a command packet, retrieving each command from the command packet, and executing each command retrieved from the command packet.

19. The method of claim 18, further comprising:
storing each command retrieved from the command packet in a command queue before executing; and
selecting a stored command from the command queue for execution, wherein the selection is based on execution efficiency rather than the sequence in which the commands where retrieved from the command packet.

20. The method of claim 18, wherein the step of receiving the frame unit from the host system includes a handshake operation, and the frame unit includes:
a primitive command indicating the start of the frame unit;
a primitive command indicating the end of the frame unit; and
error correction information.
